(19) United States
(12) Patent Application Publication
(10) Pub. No.: US 2026/0133828 A1
(43) Pub. Date: May 14, 2026

(54) SYSTEMS AND METHODS FOR OPTIMIZING USAGE OF MEDIA PROCESSING CONTAINERS

(71) Applicant: Netflix, Inc., Los Gatos, CA (US)

(72) Inventors: Olof Johansson, Los Gatos, CA (US); Rosanna Kam Shui Lee, Palo Alto, CA (US); Ameya Ramesh Vasani, San Jose, CA (US); Poorna Chandra Tejashvi Reddy, Fremont, CA (US)

(21) Appl. No.: 19/348,328

(22) Filed: Oct. 2, 2025

Related U.S. Application Data
(60) Provisional application No. 63/719,763, filed on Nov. 13, 2024.

(51) Int. Cl. G06F 9/48

(52) U.S. Cl. CPC G06F 9/4887

(57) ABSTRACT

A system includes one or more storage devices and circuitry. In one example, the one or more storage devices are configured to queue a plurality of media processing jobs. In this example, the circuitry is configured to estimate execution times for the jobs in the queue and to determine a completion deadline for the jobs. Additionally or alternatively, the circuitry is further configured to calculate a number of containers needed to complete the jobs by the deadline based at least in part on the estimated execution times and to implement the calculated number of containers to process the jobs by the completion deadline. Various other methods, systems, and computer-readable media are also disclosed.

### CROSS REFERENCE TO RELATED APPLICATION

This application claims the benefit of U.S. Provisional Application No. 63/719,763 filed Nov. 13, 2024, the disclosure of which is incorporated in its entirety by this reference.

### BACKGROUND

In modern cloud-based media processing platforms, compute resources like containers are used to execute a wide variety of jobs (e.g., encoding, transcoding, asset generation, etc.). The scheduling of resource allocation for processing such jobs can impact service level objectives and/or operational costs. For example, some conventional media processing platforms allocate containers to collectively process the jobs in parallel and/or simultaneously. Unfortunately, such parallel processing can lead to elevated costs, reduced container utilization, and/or longer queue wait times for media processing jobs.

The instant disclosure, therefore, identifies and addresses a need for improved systems and methods capable of optimizing usage of media processing containers to reduce costs, increase container utilization, and/or shorten queue wait times.

### SUMMARY

As will be described in greater detail below, the present disclosure describes systems and methods for optimizing usage of media processing containers. In some examples, a system includes one or more storage devices and circuitry. In one example, the one or more storage devices are configured to queue a plurality of media processing jobs. In this example, the circuitry is configured to estimate execution times for the jobs in the queue and to determine a completion deadline for the jobs. Additionally or alternatively, the circuitry is further configured to calculate a number of containers needed to complete the jobs by the deadline based at least in part on the estimated execution times and to implement the calculated number of containers to process the jobs by the completion deadline.

In some examples, the circuitry is further configured to estimate an execution time for each job in the queue based at least in part on a function of the job and a resource requirement of the job and to calculate the number of containers needed to complete each job in the queue by the completion deadline. Additionally or alternatively, the circuitry is configured to allocate, from a pool of containers, the number of containers to process the jobs and to spin up the allocated containers to process the jobs by the completion deadline.

In some examples, the circuitry is further configured to estimate additional execution times for additional jobs in an additional queue and to determine an additional completion deadline for the additional jobs. In such examples, the circuitry is further configured to calculate an additional number of containers needed to complete the additional jobs by the additional completion deadline and to schedule the allocation of containers to process jobs at a certain time based at least in part on the deadline and the additional deadline. In one example, the plurality of jobs in the queue share a job type in common, and/or the additional jobs in the additional queue share an additional job type in common.

In some examples, the circuitry is further configured to determine a number of jobs in the queue and to determine a total number of containers in the pool. In such examples, the circuitry is further configured to schedule the allocation of containers based at least in part on the deadline, the additional deadline, the number of jobs in the queue, the execution times for the jobs, and the total number of containers in the pool.

In some examples, the circuitry is further configured to determine that the number of containers have completed the jobs in the queue and to terminate the containers in response to completion. In such examples, the circuitry is further configured to release the containers to a pool for reallocation to additional jobs. Additionally or alternatively, the circuitry is configured to maintain the containers in an active state of processing jobs sequentially without entering an idle state until all jobs have been completed.

In some examples, the circuitry is further configured to determine a number of the jobs in the queue and to calculate the number of containers needed to complete each job in the queue by the completion deadline based at least in part on the number of jobs in the queue. In one example, the circuitry is further configured to implement an artificial intelligence (AI) model to estimate execution times for the jobs in the queue based at least in part on previous execution times of comparable jobs, a job type of the jobs, and/or a resource requirement of the jobs. Additionally or alternatively, the circuitry is configured to obtain recent execution times of recent jobs that are comparable to the jobs in the queue and to update one or more of the estimated execution times for the jobs in the queue based at least in part on the recent execution times.

In some examples, the circuitry is further configured to assign a first priority level to a first subset of the jobs in the queue and to assign a second priority level that is higher than the first priority level to a second subset of the jobs. In such examples, the circuitry is further configured to allocate, due at least in part to the second subset of jobs having been assigned the higher priority level, one of the containers to the second subset of jobs prior to allocating any of the containers to the first subset of jobs.

In some examples, a corresponding computer-implemented method involves (1) identifying, by circuitry, a queue that includes a plurality of jobs to be completed by one or more containers, (2) estimating, by the circuitry, execution times for the jobs included in the queue, (3) determining, by the circuitry, a completion deadline of the jobs included in the queue, (4) calculating, by the circuitry, a number of containers that are needed to complete the jobs by the completion deadline based at least in part on the execution times for the jobs, and (5) implementing, by the circuitry, the number of containers to process the jobs by the completion deadline.

In some examples, a non-transitory computer-readable medium comprises one or more computer-executable instructions that, when executed by circuitry incorporated in a system, cause the system to (1) identify a queue that includes a plurality of jobs to be completed by one or more containers, (2) estimate execution times for the jobs included in the queue, (3) determine a completion deadline of the jobs included in the queue, (4) calculate a number of containers that are needed to complete the jobs by the completion deadline based at least in part on the execution times for the jobs, and (5) implement the number of containers to process the jobs by the completion deadline.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for optimizing usage of media processing containers in accordance with one or more implementations of this disclosure.

FIG. 2 illustrates an exemplary system for optimizing usage of media processing containers in accordance with one or more implementations of this disclosure.

FIG. 3 illustrates an exemplary implementation of optimizing usage of media processing containers in accordance with one or more implementations of this disclosure.

FIG. 4 illustrates an exemplary representation of information used to estimate execution times for jobs in a queue in accordance with one or more implementations of this disclosure.

FIG. 5 illustrates an exemplary implementation of optimizing usage of media processing containers in accordance with one or more implementations of this disclosure.

FIG. 6 illustrates an exemplary representation of estimated execution times for jobs in a queue in accordance with one or more implementations of this disclosure.

FIG. 7 illustrates an exemplary method for optimizing usage of media processing containers in accordance with one or more implementations of this disclosure.

FIG. 8 illustrates a block diagram of an exemplary content distribution ecosystem.

FIG. 9 illustrates a block diagram of an exemplary distribution infrastructure within the content distribution ecosystem shown in FIG. 8.

FIG. 10 illustrates a block diagram of an exemplary content player within the content distribution ecosystem shown in FIG. 9.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for optimizing the allocation and utilization of containers in cloud-based media processing platforms. As will be explained in greater detail below, these systems and methods can provide numerous features and benefits over conventional technologies, such as improving resource utilization, reducing operational costs, and/or meeting service level objectives in media processing environments.

In some examples, container allocation can refer to and/or represent the process of determining the number of containers needed to complete all the jobs loaded in a queue and/or scheduling the allocation, spin-up, and/or termination of such containers in connection with those jobs. Various factors can contribute and/or lead to inefficiencies in conventional container-allocation technologies. Examples of such factors include, without limitation, inaccurate job execution time estimates, aggressive scaling based on queue depth, failure to account for job types, failure to account for resource requirements, and/or failure to account for priority levels. Unfortunately, the inefficiencies can result in high container churn, underutilized resources, increased overhead, and/or elevated costs.

In some examples, a system capable of overcoming such inefficiencies includes and/or represents one or more storage devices queue various jobs to be completed by one or more containers. Examples of such jobs include, without limitation, encoding jobs, transcoding jobs, stream generation jobs, thumbnail creation jobs, asset inspection jobs, fingerprinting jobs, media processing jobs, combinations or variations of one or more of the same, and/or any other suitable jobs. In one example, the system maintains a pool of containers available for allocation to process the jobs loaded across a set of queues. In this example, the jobs loaded in any given queue can involve and/or implicate different resource requirements—such as differing levels of processor usage, memory usage, bandwidth usage, input/output (I/O) operations, etc.—even if those jobs share the same job type.

In some examples, the system also includes and/or represents circuitry configured to estimate execution times and/or durations for the jobs loaded in the queues. The estimations can be based on and/or account for a variety of different attributes of the jobs, including the types and/or functions of the jobs, the resource requirements of the jobs, and/or historical or recent execution times and/or durations of comparable jobs. In one example, the circuitry executes and/or implements an artificial intelligence (AI) model trained on historical and/or recent job completion data to generate accurate execution time estimates. In this example, the circuitry periodically updates execution time estimates for the jobs in the queues based on recent completion times, thus enabling the system to adapt to evolving workloads and/or conditions.

In some examples, the circuitry determines completion deadlines—which are sometimes also referred to as target drain times—for the jobs in the queues and calculates the minimum number of containers needed to complete the jobs by the respective completion deadlines. The calculations may be based on the estimated execution times for the jobs, the number of jobs in the queues, and/or the total number of containers available in a pool. In one example, the circuitry schedules the minimum number of containers to process the jobs in the queues by their respective completion deadlines. In this example, at the scheduled time, the circuitry allocates the minimum number of containers from the pool to process the jobs in one of the queues. The circuitry then spins up the allocated containers to meet the completion deadlines.

In some examples, the circuitry maintains the allocated containers in an active state of processing jobs sequentially without idling until all jobs have been completed. Upon completion of the jobs, the circuitry terminates the spun-up containers and releases them to the pool for reallocation to additional jobs. Additionally or alternatively, the circuitry estimates additional execution times for additional jobs loaded in additional queues, determines additional completion deadlines, and/or schedules the allocation of containers to process those jobs at certain times based on the respective deadlines and/or available resources.

In some examples, the circuitry assigns priority levels to subsets of jobs in the queue. For example, a low priority level is assigned to a first subset of jobs, and a higher priority level is assigned to a second subset of jobs. In this example, the circuitry allocates and/or applies one or more containers to process the higher-priority jobs before the lower-priority jobs. By doing so, the circuitry ensures that any urgent and/or time-sensitive jobs are processed in accordance with business preferences and/or requirements.

As a specific example, a queue includes and/or contains sixty (60) jobs with an average execution time of one minute, and a system is tasked with completing all sixty (60) jobs within a one-hour deadline. With some conventional container-allocation technologies, the system would have spun up sixty (60) containers—one for each job in the queue—to process the sixty (60) jobs in parallel. Under such conventional technologies, each container would complete a single job and then terminate. While this conventional approach ensures rapid job completion, this conventional approach can result in significant overhead due to the repeated starting and stopping of containers.

However, with the improved technologies described herein, the system determines that a single container is sufficient to process all sixty (60) jobs in the queue sequentially within the one-hour deadline. By spinning up that single container to process all sixty (60) of those jobs, the system achieves savings equivalent to sixty (60) times the overhead involved in starting and/or stopping a container. Continuing with this example, the reduction in container overhead leads to a trade-off of increased queue wait time as each job waits its turn to be processed by the single container. As a result, the system is able to increase and/or improve efficiencies and/or available resources by extending the completion of the jobs in the queue until the completion deadline, as opposed to simply processing all the jobs in the queue simultaneously and/or in parallel.

In a comparable example, if the completion deadline is shortened to thirty (30) minutes instead of one (1) hour, the system can calculate that a minimum of two (2) containers are needed to process all sixty (60) jobs by the completion deadline. In this example, the queue wait time is reduced by half, and the system achieves savings equivalent to thirty (30) times the overhead involved in starting and/or stopping a container. Accordingly, the system enables dynamic container allocation based on estimated job execution times and completion deadlines to maximize cost efficiency and/or resource utilization.

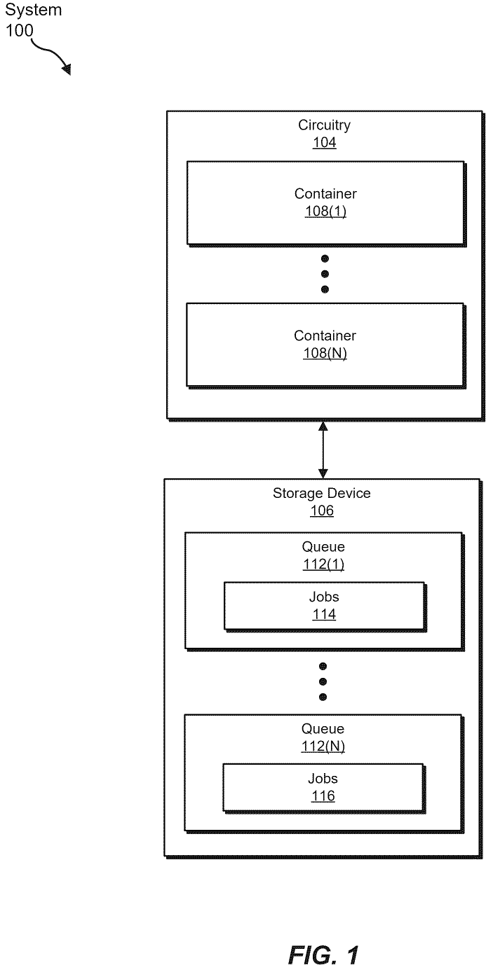

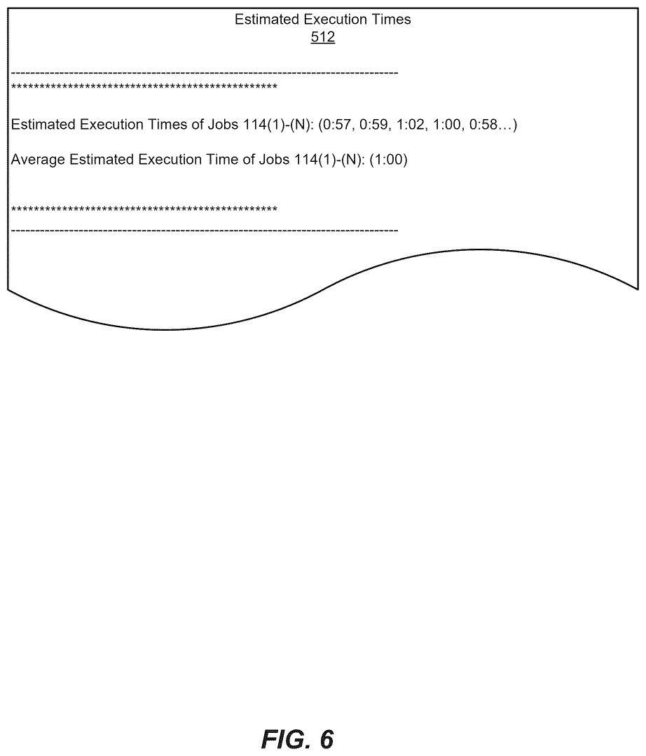

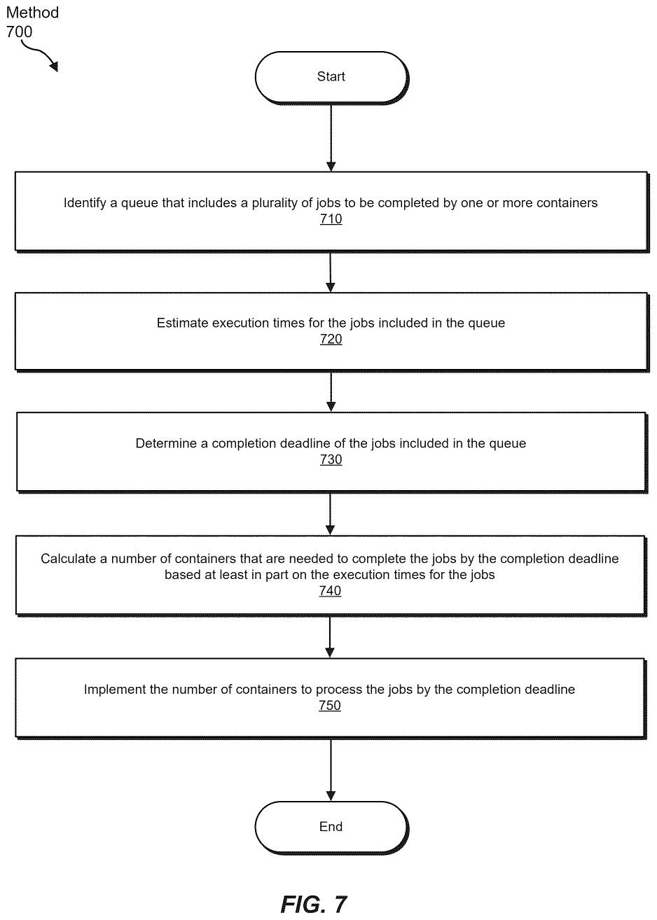

The following will provide, with reference to FIGS. 1-6 and 8-10, detailed descriptions of exemplary devices, systems, and corresponding implementations or configurations that facilitate and/or support optimizing usage of media processing containers. The following will also provide, with reference to FIG. 7, examples of methods for optimizing usage of media processing containers.

FIG. 1 illustrates an exemplary system 100 for optimizing usage of media processing containers. In some examples, system 100 includes and/or represents circuitry 104 and/or a storage device 106. In one example, circuitry 104 and/or storage device 106 interface with and/or are communicatively coupled to one another. In this example, storage device 106 stores, maintains, provides, and/or manages queues 112(1)-(N) that are loaded, populated, and/or filled with jobs. For example, queue 112(1) is loaded and/or populated with jobs 114, and queue 112(N) is loaded and/or populated with jobs 116.

In some examples, circuitry 104 manages, executes, and/or implements containers 108(1)-(N) capable of processing jobs 114 and 116. In one example, circuitry 104 schedules containers 108(1)-(N) for allocation to process jobs 114 and 116 based at least in part on their respective estimated execution times and/or completion deadlines. In this example, circuitry 104 estimates execution times for jobs 114 and 116 based at least in part on the job types and/or functions of jobs 114 and 116. In certain implementations, all of jobs 114 have or share the same job type and/or function as one another, and all of jobs 116 have or share the same job type and/or function as one another. However, the job type and/or function of jobs 114 may differ from the job type and/or function of jobs 116.

In some examples, circuitry 104 determines the completion deadlines of jobs 114 and 116. For example, circuitry 104 can receive information and/or data that indicates the completion deadline of either jobs 114 or jobs 116 from a customer associated with such jobs and/or from an upstream system or environment associated with such jobs. Additionally or alternatively, circuitry 104 may examine and/or review a policy that indicates a standard completion deadline for all jobs or certain jobs characterized by specific attributes (e.g., job type, function, etc.) after being loaded into the corresponding queues. In certain implementations, circuitry 104 may dynamically calculate the completion deadline of either jobs 114 or jobs 116 based at least in part on the current system load, job priorities, and/or downstream requirements (e.g., a customer's business needs).

In some examples, circuitry 104 determines, calculates, and/or computes the number of containers 108(1)-(N) needed to complete jobs 114 or jobs 116 by their respective completion deadlines based at least in part on the estimated execution times for jobs 114 or jobs 116. In one example, circuitry 104 calculates the minimum number of containers 108(1)-(N) needed to complete each of jobs 114 or jobs 116 by their respective completion deadlines based at least in part on the execution time for each job in queue 112(1) or queue 112(N).

In some examples, circuitry 104 can schedule the allocation of containers 108(1)-(N) to process jobs 114 or jobs 116 at a certain time based at least in part on their respective completion deadlines. For example, circuitry 104 may consider and/or take into account the completion deadlines of jobs 114 and jobs 116, the number of jobs included in queues 112(1)-(N), the estimated execution times of jobs 114 and jobs 116, and/or the total number of available containers when performing the scheduling operation and/or task. In one example, circuitry 104 allocates one or more of containers 108(1)-(N) to process jobs 114 or jobs 116 in accordance with the schedule.

In some examples, circuitry 104 executes, spins up, and/or implements the containers as allocated and/or applied to queues 112(1)-(N) to process jobs 114 and/or jobs 116. For example, one or more of containers 108(1)-(N) allocated to queue 112(1) and/or jobs 114 perform the corresponding tasks, work, and/or computational steps. In one example, circuitry 104 maintains the container(s) in an active state of processing jobs 114 sequentially without entering an idle state until all of jobs 114 have been completed.

In some examples, storage device 106 includes and/or represents any type or form of volatile or non-volatile storage device or medium capable of storing data, computer-readable instructions, and/or load-balancing options. In one example, storage device 106 maintains and/or stores one or more computer-readable instructions, modules, programs, applications, and/or load-balancing options 130(1)-(N). Examples of storage device 106 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable memory. Although illustrated as a single unit in FIG. 1, storage device 106 can alternatively include and/or represent a collection of multiple storage devices capable of storing and/or maintaining a plurality of queues and/or data corresponding to jobs loaded in those queues.

In some examples, circuitry 104 includes and/or represents one or more electrical and/or electronic circuits capable of processing, applying, modifying, transforming, displaying, transmitting, receiving, and/or executing data for system 100. In one example, circuitry 104 accesses and/or analyzes data stored in storage device 106 to facilitate and/or support optimizing usage of media processing containers. Additionally or alternatively, circuitry 104 launches, performs, and/or executes certain executable files, code snippets, and/or computer-readable instructions to facilitate and/or support optimizing usage of media processing containers.

Although illustrated as a single unit in FIG. 1, circuitry 104 can include and/or represent a collection of multiple processing units and/or electrical or electronic components that work and/or operate in conjunction with one another. Examples of circuitry 104 include, without limitation, processing devices, hardware processors, microprocessors, microcontrollers, field-programmable gate arrays (FPGAs), application-specific integrated circuits (ASICs), graphics processing units (GPUs), central processing units (CPUs), systems on chips (SoCs), parallel accelerated processors, tensor cores, integrated circuits, chiplets, receivers, transmitters, transceivers, storage devices, memory devices, digital logic, analog circuitry, digital circuitry, portions of one or more of the same, variations or combinations of one or more of the same, and/or any other suitable circuitry. In certain implementations, circuitry 104 can be distributed across multiple devices (e.g., remote and/or network devices).

In some examples, containers 108(1)-(N) each refer to and/or represent a lightweight, isolated, and/or virtualized computing environment that encapsulates the software, dependencies, and/or runtime necessary to execute one or more jobs. In one example, containers 108(1)-(N) are managed by system 100 and can be dynamically allocated, spun up, maintained in an active state, and/or terminated as needed to process the jobs in the queues across system 100. Additionally or alternatively, containers 108(1)-(N) can provide a consistent and/or portable execution environment that facilitates processing jobs independently of the underlying hardware and/or operating system. In certain implementations, system 100 can orchestrate and/or collect containers 108(1)-(N) as part of a pool or fleet. By doing so, system 100 facilitates and/or supports efficient resource utilization, rapid scaling, and/or flexible job scheduling.

In some examples, jobs 114 and 116 each constitute and/or represent a media processing job, operation, and/or task. Examples of jobs 114 and 116 include, without limitation, encoding jobs, transcoding jobs, stream generation jobs, thumbnail creation jobs, asset inspection jobs, fingerprinting jobs, media processing jobs, combinations or variations of one or more of the same, and/or any other suitable jobs.

In some examples, system 100 includes and/or represent one or more media servers, devices, and/or environments. In one example, system 100 includes and/or represents a data center and/or a distributed system that handles, processes, and/or delivers streaming media. Additionally or alternatively, system 100 includes and/or represents a collection of components and/or devices included in and/or distributed across a client-server network.

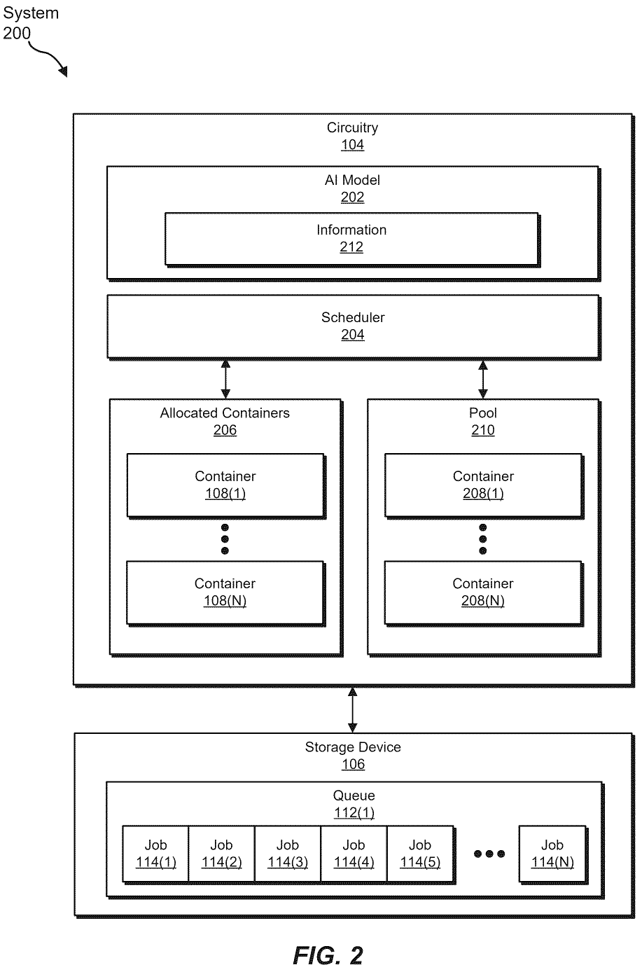

FIG. 2 illustrates an exemplary system 200 that facilitates and/or supports optimizing usage of media processing containers. In some examples, system 200 in FIG. 2 includes and/or involves certain devices, components, configurations, and/or features that perform and/or provide functionalities that are similar and/or identical to those described above in connection with FIG. 1. In one example, system 200 includes and/or represents circuitry 104 and/or storage device 106. In this example, circuitry 104 executes and/or implements an artificial intelligence (AI) model 202, a scheduler 204, allocated containers 206, and/or a pool 210.

In some examples, allocated containers 206 include and/or represent containers 108(1)-(N). In one example, pool 210 includes and/or represents containers 208(1)-(N). In this example, containers 208(1)-(N) have been released and/or are available for allocation to process jobs. In certain implementations, queue 112(1) includes and/or is loaded with jobs 114(1), 114(2), 114(3), 114(4), 114(5), and/or 114(N).

In some examples, circuitry 104 executes, implements, and/or leverages AI model 202 to estimate the execution times 512 for jobs 114(1)-(N) in queue 112(1). In one example, circuitry 104 provides and/or inputs information 212 to AI model 202. In this example, AI model 202 estimates the execution times for jobs 114(1)-(N) in queue 112(1)-(N) based at least in part on information 212. Additionally or alternatively, AI model 202 provides and/or transmits those execution times to scheduler 204 for making scheduling decisions.

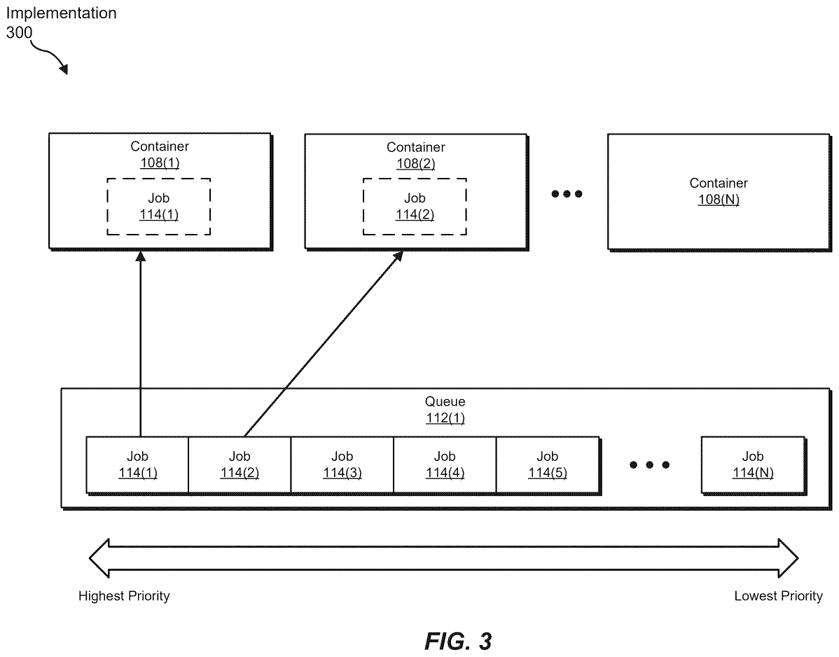

FIG. 3 illustrates an exemplary implementation 300 for optimizing usage of media processing containers. In some examples, implementation 300 in FIG. 3 includes and/or involves certain devices, components, configurations, and/or features that perform and/or provide functionalities that are similar and/or identical to those described above in connection with either FIG. 1 or FIG. 2. In one example, circuitry 104 assigned differing priority levels to jobs 114(1)-(N) based at least in part on the needs of a customer and/or specific request. For example, circuitry 104 can assign a higher priority level to job 114(1) and a lower priority level to job 114(N). In this example, circuitry 104 can assign other and/or different priority levels to the remaining jobs loaded in queue 112(1) such that jobs 114(1)-(N) are arranged in order of priority in queue 112(1).

In some examples, containers 108(1)-(N) can be deployed and/or applied to process jobs 114(1)-(N) in order of priority. In one example, container 108(1) processes job 114(1), and container 108(2) processes job 114(2). In this example, containers 108(1)-(N) can process jobs 114(1)-(N) in parallel. However, because the number of jobs 114(1)-(N) exceeds the number of containers 108(1)-(N), containers 108(1)-(N) process the jobs of highest priority first before processing those jobs of lower priority.

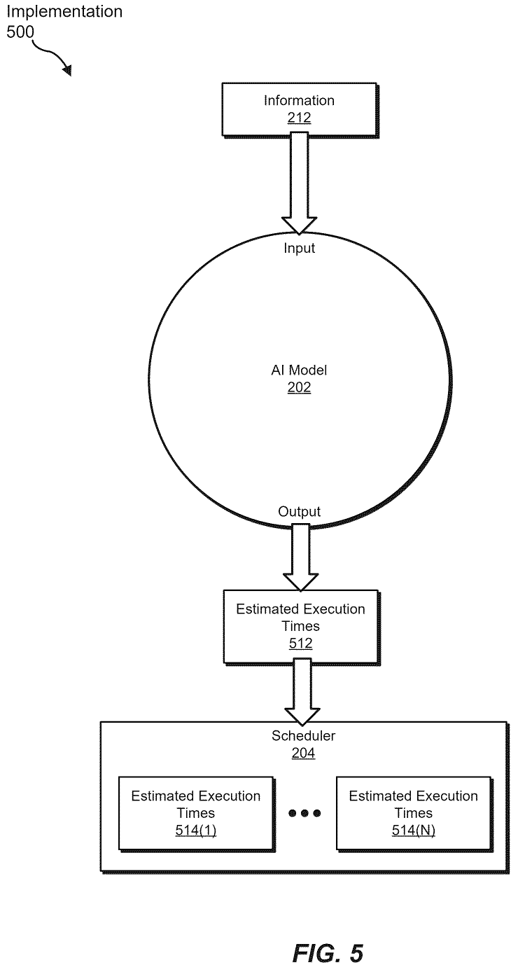

FIG. 5 illustrates an exemplary implementation 500 of AI model 202 and/or scheduler 204 capable of optimizing usage of media processing containers. In some examples, implementation 500 in FIG. 5 includes and/or involves certain devices, components, configurations, and/or features that perform and/or provide functionalities that are similar and/or identical to those described above in connection with either FIG. 1 or FIG. 2. In one example, circuitry 104 executes, implements, and/or leverages AI model 202 to estimate the execution times 512 for jobs 114(1)-(N) in queue 112(1). In this example, AI model 202 is trained with historical and/or recent job completion data. Examples of such job completion data include, without limitation, the actual execution and/or completion times, the respective job types, the respective resource requirements (e.g., processor usage, memory usage, bandwidth usage, etc.), I/O operations data associated to the jobs, the corresponding system state and/or environments, combinations or variations of one or more of the same, and/or any other suitable job completion data.

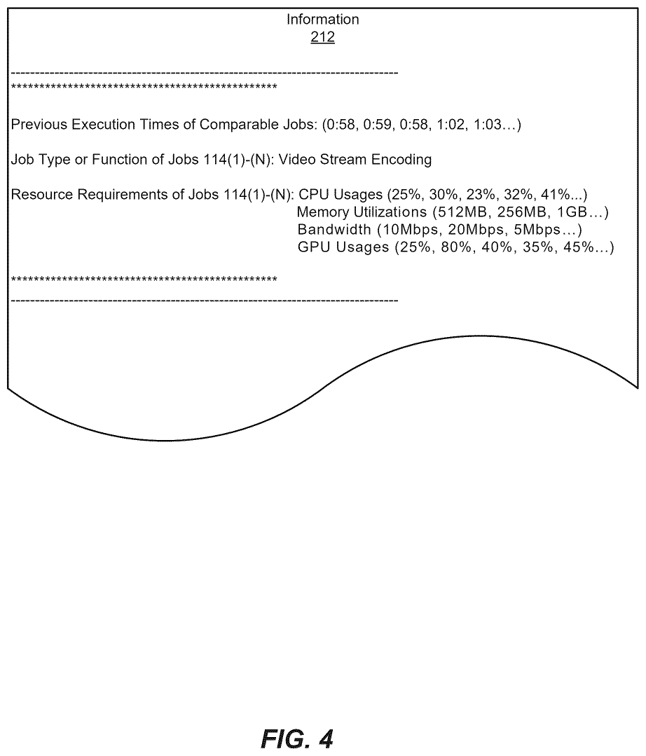

In some examples, circuitry 104 provides and/or inputs information 212 to AI model 202. In one example, AI model 202 uses information 212 to estimate the execution times of jobs 114(1)-(N). As illustrated in FIG. 4, information 212 can include and/or represent previous execution times of comparable jobs (e.g., 0:58, 0:59, 1:02, 1:03, etc.), the job type or function of jobs 114(1)-(N) (e.g., video stream encoding), and/or the resource requirements of jobs 114(1)-(N). In one example, the resource requirements represented in information 212 include and/or represents CPU usages (e.g., 25%, 30%, 23%, 32%, 41%, etc.), memory utilizations (e.g., 512 megabytes (MB), 256 MB, 1 gigabytes (GB), etc.), bandwidth (e.g., 10 megabits per second (Mbps), 20 Mbps, 5 Mbps, etc.), and/or GPU usages (e.g., 25%, 80%, 40%, 35%, 45%, etc.).

In some examples, AI model 202 provides and/or transmits estimated execution times 512 for jobs 114(1)-(N) to scheduler 204. In one example, scheduler 204 receives estimated execution times 512 and then examines and/or reviews estimated execution times 512. In this example, scheduler 204 can schedule the allocation of containers 108(1)-(N) to process jobs 114(1)-(N) included in queue 112(1) based at least in part on the completion deadlines of jobs 114(1)-(N), the number of jobs included in queue 112(1), the estimated execution times of jobs 114(1)-(N), and/or the total number of available containers in pool 210.

In some examples, scheduler 204 obtains similar and/or identical information or data associated with other jobs loaded in other queues in system 200. In one example, scheduler 204 schedules the allocation of containers 108(1)-(N) to process jobs 114(1)-(N) included in queue 112(1) in view of the needs (e.g., estimated execution times, completion deadlines, resource requirements, etc.) of all those jobs. For example, scheduler 204 can schedule the allocation of containers 108(1)-(N) to process jobs 114(1)-(N) based at least in part on estimated execution times 512 as well as estimated execution times 514(1)-(N) corresponding to other queues and/or jobs.

In some examples, circuitry 104 can periodically update, revise, and/or retrain AI model 202 based at least in part new information and/or data (e.g., more recent job completion data and/or execution times). Additionally or alternatively, circuitry 104 can update and/or revise estimated execution times 512 for jobs 114(1)-(N) in queue 112(1) based at least in part on more recent completed execution times of comparable jobs. As illustrated in FIG. 5, estimated execution times 512 can include and/or represent individual execution times of jobs 114(1)-(N) (e.g., 0:57, 0:59, 1:04, 1:02, 0:58, etc.) and/or the average estimated execution time of jobs 114(1)-(N) (e.g., 1:00).

In some examples, the various systems, components, and/or features described in connection with FIGS. 1-6 may include and/or represent one or more additional circuits, components, and/or features that are not necessarily illustrated and/or labeled in FIGS. 1-3. For example, the systems, components, and/or features illustrated in FIGS. 1-6 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, networks, combinations or variations of one or more of the same, and/or any other suitable components. In certain implementations, one or more of these additional circuits, components, and/or features may be inserted and/or applied between any of the existing circuits, components, and/or features illustrated in FIGS. 1-6 consistent with the aims and/or objectives described herein. Accordingly, the couplings and/or connections described with reference to FIGS. 1-6 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In one example, the indirect coupling may include and/or incorporate at least one additional computing device between two computing devices illustrated in any of FIGS. 1-6. In some implementations, one or more components and/or devices illustrated in FIGS. 1-6 may be omitted and/or excluded from the corresponding systems.

FIG. 7 is a flow diagram of an exemplary computer-implemented method 700 for optimizing usage of media processing containers. In one example, the steps shown in FIG. 7 are performed by circuitry incorporated and/or implemented in one or more systems and/or computing devices. Additionally or alternatively, the steps shown in FIG. 7 incorporate and/or involve certain sub-steps and/or variations consistent with the descriptions provided above in connection with FIGS. 1-6.

As illustrated in FIG. 7, method 700 includes and/or involves the step of identifying a queue that includes a plurality of jobs to be completed by one or more containers (710). Step 710 is performed in a variety of ways, including any of those described above in connection with FIGS. 1-6. For example, circuitry included in a system can identify a queue that includes a plurality of jobs to be completed by one or more containers.

Method 700 also includes and/or involves the step of estimating execution times for the jobs included in the queue (720). Step 720 is performed in a variety of ways, including any of those described above in connection with FIGS. 1-6. For example, the circuitry estimates execution times for the jobs included in the queue.

Method 700 further includes and/or involves the step of determining a completion deadline of the jobs included in the queue (730). Step 730 is performed in a variety of ways, including any of those described above in connection with FIGS. 1-6. For example, the circuitry determines a completion deadline of the jobs included in the queue.

Method 700 further includes and/or involves the step of calculating a number of containers that are needed to complete the jobs by the completion deadline based at least in part on the execution times for the jobs (740). Step 740 is performed in a variety of ways, including any of those described above in connection with FIGS. 1-6. For example, the circuitry calculates a number of containers that are needed to complete the jobs by the completion deadline based at least in part on the execution times for the jobs.

Method 700 further includes and/or involves the step of implementing the number of containers to process the jobs by the completion deadline (750). Step 750 is performed in a variety of ways, including any of those described above in connection with FIGS. 1-6. For example, the circuitry implements the number of containers to process the jobs by the completion deadline.

Furthermore, a non-transitory computer-readable medium comprises one or more computer-executable instructions that, when executed by circuitry incorporated in a system, cause the system to (1) identify a queue that includes a plurality of jobs to be completed by one or more containers, (2) estimate execution times for the jobs included in the queue, (3) determine a completion deadline of the jobs included in the queue, (4) calculate a number of containers that are needed to complete the jobs by the completion deadline based at least in part on the execution times for the jobs, and (5) implement the number of containers to process the jobs by the completion deadline.

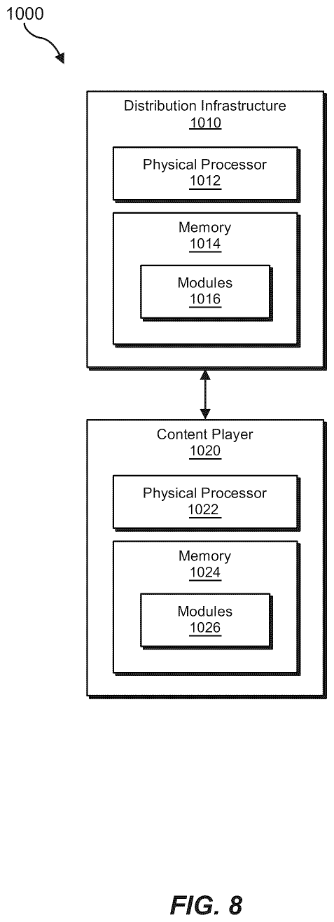

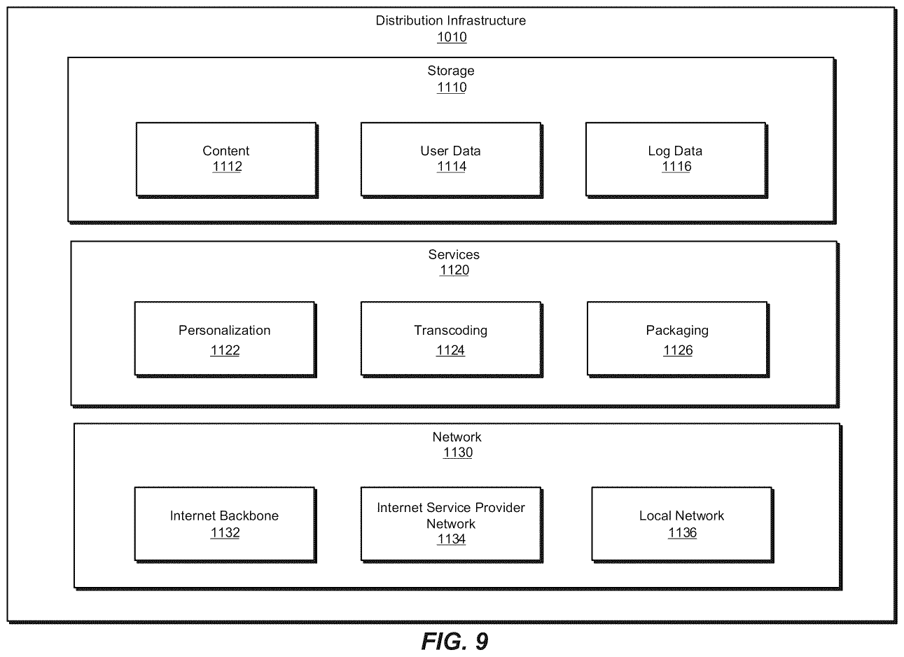

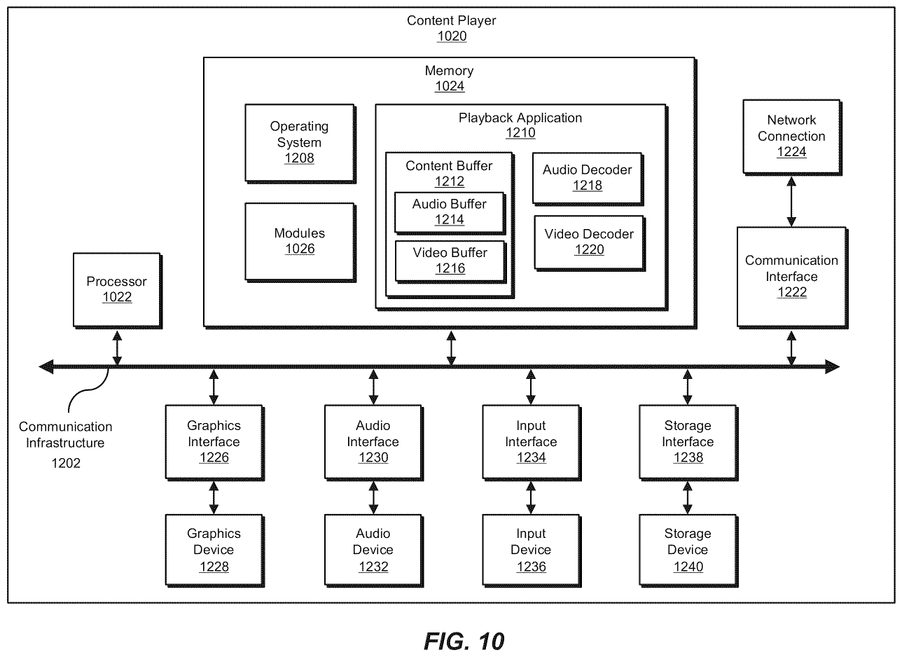

The following will provide, with reference to FIG. 8, detailed descriptions of exemplary ecosystems in which content is provisioned to end nodes and in which requests for content are steered to specific end nodes. The discussion corresponding to FIGS. 9 and 10 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 8 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 8 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 8 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Transcoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 10 is a block diagram of an exemplary implementation of content player 1020 of FIG. 8. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 10, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 10 need not be present to practice the embodiments described and/or illustrated herein. The devices and subsystems referenced above are also interconnected in different ways from that shown in FIG. 10. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
one or more storage devices configured to queue a plurality of jobs to be completed by one or more containers; and
circuitry configured to:
estimate execution times for the jobs in the queue;
determine a completion deadline of the jobs in the queue;
calculate a number of containers that are needed to complete the jobs by the completion deadline based at least in part on the execution times for the jobs; and
implement the number of containers to process the jobs by the completion deadline.

2. The system of claim 1, wherein the circuitry is further configured to:
estimate an execution time for each job in the queue based at least in part on a function of the job and a resource requirement of the job; and
calculate the number of containers needed to complete each job in the queue by the completion deadline based at least in part on the execution time for each job in the queue.

3. The system of claim 1, wherein the circuitry is further configured to:
allocate, from a pool of containers, the number of containers to process the jobs; and
spin up the allocated containers to process the jobs by the completion deadline.

4. The system of claim 3, wherein the circuitry is further configured to:
estimate additional execution times for additional jobs in an additional queue;
determine an additional completion deadline of the additional jobs in the additional queue;
calculate an additional number of containers that are needed to complete the additional jobs by the additional completion deadline based at least in part on the additional execution times for the additional jobs; and
schedule the allocation of the number of containers to process the jobs at a certain time based at least in part on the deadline and the additional deadline.

5. The system of claim 4, wherein the circuitry is further configured to:
determine a number of the jobs in the queue;
determine a total number of the containers in the pool; and
schedule the allocation of the number of containers to process the jobs at the certain time based at least in part on the deadline, the additional deadline, the number of jobs in the queue, the execution times for the jobs in the queue, and the total number of containers in the pool.

6. The system of claim 4, wherein:
the plurality of jobs in the queue share a job type in common; and
the additional jobs in the additional queue share an additional job type in common.

7. The system of claim 1, wherein the circuitry is further configured to:
determine that the number of containers have completed the jobs in the queue;
terminate the number of containers in response to determining that the number of containers have completed the jobs in the queue; and
release the number of containers to a pool of containers capable of being reallocated to process one or more additional jobs.

8. The system of claim 7, wherein the circuitry is further configured to maintain the number of containers in an active state of processing the jobs sequentially without entering an idle state until all the jobs have been completed.

9. The system of claim 1, wherein the circuitry is further configured to:
determine a number of the jobs in the queue; and
calculate the number of containers needed to complete each job in the queue by the completion deadline based at least in part on the number of jobs in the queue.

10. The system of claim 1, wherein the circuitry is further configured to implement an artificial intelligence (AI) model to estimate execution times for the jobs in the queue based at least in part on one or more of:
previous execution times of previous jobs that are comparable to the jobs in the queue;
a job type of the jobs in the queue; or
a resource requirement of the jobs in the queue.

11. The system of claim 1, wherein the circuitry is further configured to:
obtain recent execution times of recent jobs that are comparable to the jobs in the queue; and
update one or more of the estimated execution times for the jobs in the queue based at least in part on the recent execution times.

12. The system of claim 1, wherein the circuitry is further configured to:
assign a first priority level to a first subset of the jobs in the queue;
assign a second priority level that is higher than the first priority level to a second subset of the jobs in the queue; and
allocate, due at least in part to the second subset of jobs having been assigned the second priority level, one of the containers to the second subset of jobs prior to allocating any of the containers to the first subset of jobs.

13. A method comprising:
identifying, by circuitry, a queue that includes a plurality of jobs to be completed by one or more containers;
estimating, by the circuitry, execution times for the jobs included in the queue;
determining, by the circuitry, a completion deadline of the jobs included in the queue;
calculating, by the circuitry, a number of containers that are needed to complete the jobs by the completion deadline based at least in part on the execution times for the jobs; and
implementing, by the circuitry, the number of containers to process the jobs by the completion deadline.

14. The method of claim 13, wherein:
estimating the execution times for the jobs comprises estimating an execution time for each job included in the queue based at least in part on a function of the job and a resource requirement of the job; and
calculating the number of containers comprises calculating the number of containers needed to complete each job included in the queue by the completion deadline based at least in part on the execution time for each job included in the queue.

15. The method of claim 13, further comprising:
allocating, by the circuitry, the number of containers to process the jobs from a pool of containers; and
spinning up, by the circuitry, the allocated containers to process the jobs by the completion deadline.

16. The method of claim 15, further comprising:
estimating, by the circuitry, additional execution times for additional jobs included in an additional queue;
determining, by the circuitry, an additional completion deadline of the additional jobs included in the additional queue;
calculating, by the circuitry, an additional number of containers that are needed to complete the additional jobs by the additional completion deadline based at least in part on the additional execution times for the additional jobs; and
scheduling, by the circuitry, the allocation of the number of containers to process the jobs at a certain time based at least in part on the deadline and the additional deadline.

17. The method of claim 16, further comprising:
determining, by the circuitry, a number of the jobs included in the queue;
determining, by the circuitry, a total number of the containers in the pool; and
scheduling, by the circuitry, the allocation of the number of containers to process the jobs at the certain time based at least in part on the deadline, the additional deadline, the number of jobs included in the queue, the execution times for the jobs included in the queue, and the total number of containers in the pools.

18. The method of claim 16, wherein:
the plurality of jobs included in the queue share a job type in common; and
the additional jobs included in the additional queue share an additional job type in common.

19. The method of claim 13, further comprising:
determining, by the circuitry, that the number of containers have completed the jobs;
terminating, by the circuitry, the number of containers in response to determining that the number of containers have completed the jobs; and
releasing, by the circuitry, the number of containers to a pool of containers capable of being reallocated to process one or more additional jobs.

20. A non-transitory computer-readable medium comprising one or more computer-executable instructions that, when executed by circuitry incorporated in a system, cause the system to:
identify a queue that includes a plurality of jobs to be completed by one or more containers;
estimate execution times for the jobs included in the queue;
determine a completion deadline of the jobs included in the queue;
calculate a number of containers that are needed to complete the jobs by the completion deadline based at least in part on the execution times for the jobs; and
implement the number of containers to process the jobs by the completion deadline.
